(19) United States
(12) Patent Application Publication
(10) Pub. No.: US 2009/0060035 A1
(43) Pub. Date: Mar. 5, 2009

(54) TEMPORAL SCALABILITY FOR LOW DELAY SCALABLE VIDEO CODING

(75) Inventors: Zhongli He, Austin, TX (US); Yong Yan, Austin, TX (US); Yolanda Prieto, Miami, FL (US)

Correspondence Address: Huffman Law Group, P.C., 1900 Mesa Ave., Colorado Springs, CO, 80906, US

(73) Assignee: FREESCALE SEMICONDUCTOR, INC., Austin, TX (US)

(21) Appl. No.: 11/846,196

(22) Filed: Aug. 28, 2007

(51) Int. Cl. H04N 7/32

(52) U.S. Cl. 375/240.12; 375/E07.243

(57) ABSTRACT

A method of processing video information which includes receiving encoded video information including an encoded base layer frame and encoded enhanced layer frames for providing temporal scalability, decoding the encoded video information in display order, and using a decoded first enhanced layer frame as a reference frame for decoding a second enhanced layer frame for forward prediction. Processing the video information in display order and using a decoded enhanced layer frame as a reference frame for processing another enhanced layer frame for forward prediction reduces coding latency for achieving temporal scalability for low delay scalable video coding. The coding memory space may also be reduced as compared to bidirectional prediction coding since the number of reference frames used for coding may be reduced.

### BACKGROUND OF THE INVENTION

1. Field of the Invention

The present invention relates in general to video information processing, and more specifically, to a system and method for implementing temporal scalability for low delay scalable video coding.

2. Description of the Related Art

The Advanced Video Coding (AVC) standard, Part 10 of MPEG4 (Motion Picture Experts Group), otherwise known as H.264, includes advanced compression techniques that were developed to enable transmission of video signals at a lower bit rate or storage of video signals using less storage space. The newer standard outperforms video compression techniques of prior standards in order to support higher quality streaming video at lower bit-rates and to enable internet-based video and wireless applications and the like. The standard does not define the CODEC (encoder/decoder pair) but instead defines the syntax of the encoded video bitstream along with a method of decoding the bitstream. Each video frame is subdivided and encoded at the macroblock (MB) level, where each MB is a 16×16 block of pixel values. Each MB is encoded in “intra” mode in which a prediction MB is formed based on reconstructed MBs in the current frame, or “inter” mode in which a prediction MB is formed based on reference MBs from one or more reference frames. The intra coding mode applies spatial information within the current frame in which the prediction MB is formed from samples in the current frame that have previously encoded, decoded and reconstructed. The inter coding mode utilizes temporal information from previous and/or future reference frames to estimate motion to form the prediction MB. The video information is typically processed and transmitted in slices, in which each video slice incorporates one or more macroblocks.

Scalable Video Coding (SVC) is an extension of the H.264 standard which addresses coding schemes for reliable delivery of video to diverse clients over heterogeneous networks using available system resources, particularly in scenarios where the downstream client capabilities, system resources, and network conditions are not known in advance, or dynamically changing from time to time. SVC provides multiple levels or layers of scalability including temporal scalability, spatial scalability, complexity scalability and quality scalability. Temporal scalability generally refers to the number of frames per second (fps) of the video stream, such as 7.5 fps, 15 fps, 30 fps, etc. Spatial scalability refers to the resolution of each frame, such as the common interface format (CIF) with 352 by 288 pixels per frame, quarter CIF (QCIF) with 176 by 144 pixels per frame, and other resolutions, such as 4CIF, QVGA, VGA, SVGA, D1, HDTV, etc. Complexity scalability generally refers to the various computational capabilities and processing power of the devices processing the video information. Quality scalability generally refers to the visual quality layers of the coded video by using different bitrates. Objectively, visual quality is measured with a peak signal-to-noise (PSNR) metric defining the relative quality of a reconstructed image compared with an original image.

Conventional SVC is particularly useful for real time, low delay applications, such as video phone, videoconferencing, video surveillance, etc. Temporal scalability for conventional SVC, however, is not efficient since it employs a hierarchical B-frame coding style which introduces significant coding latency. The hierarchical bidirectional frame or “B-frame” coding method does not code video frames in display order so that additional memory is required for storing reference frames and coding delays occur during encoding and decoding.

### BRIEF DESCRIPTION OF THE DRAWINGS

The benefits, features, and advantages of the present invention will become better understood with regard to the following description, and accompanying drawings where:

FIG. 1 is a simplified block diagram of an SVC video system implemented according to an exemplary embodiment;

FIG. 2 is a figurative block diagram illustrating the conventional hierarchical B-frame coding structure used for H.264 and conventional SVC according to prior art for temporal scalability having a GOP size of 4;

FIG. 3 is a figurative block diagram illustrating a coding structure according to an exemplary embodiment for implementing temporal scalability for low delay SVC for a GOP size of 4;

FIG. 4 is a figurative block diagram illustrating a coding structure according to an exemplary embodiment for implementing temporal scalability for low delay SVC for a GOP size of 8;

FIG. 5 is a flowchart diagram illustrating exemplary operation of the SVC video encoder of FIG. 1 according to an exemplary embodiment; and

FIG. 6 is a flowchart diagram illustrating exemplary operation of the SVC video decoder of FIG. 1 according to an exemplary embodiment.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present disclosure describes video information processing systems according to exemplary embodiments of the present invention. It is intended, however, that the present disclosure apply more generally to any of various types of “video information” including video sequences (e.g. MPEG), image information, image sequencing information, etc. The term “video information” as used herein is intended to apply to any video or image or image sequence information.

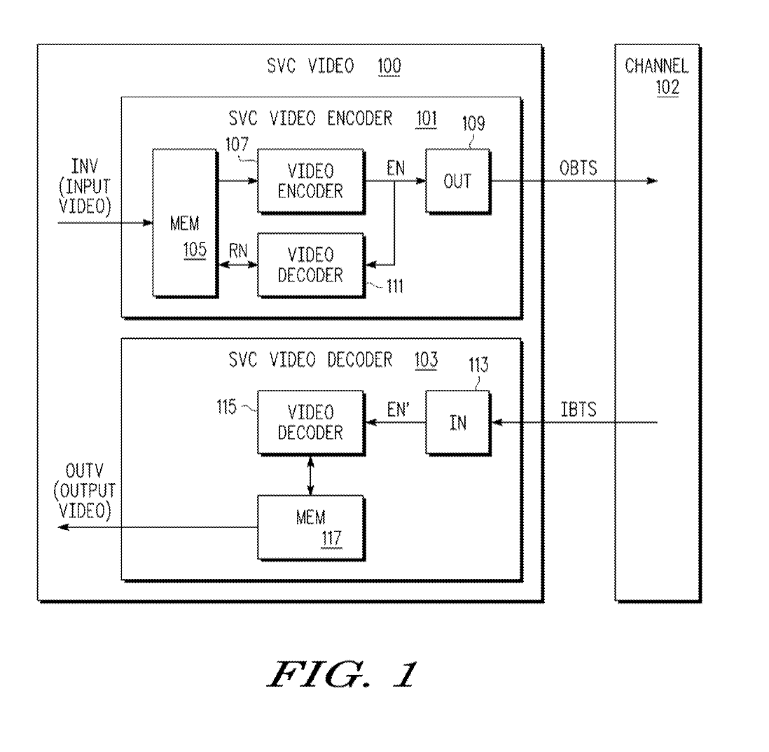

FIG. 1 is a simplified block diagram of an SVC video system 100 implemented according to an exemplary embodiment. The SVC video system 100 includes an SVC video encoder 101 and an SVC video decoder 103 incorporated within a common SVC device. A device incorporating either one of the SVC video encoder 101 or the SVC video decoder 103 is contemplated as well. The video encoder 101 encodes input video (INV) information and encapsulates the encoded video information into an output bitstream (OBTS) asserted onto a channel 102. An input BTS (IBTS) is provided via the channel 102 to the video decoder 103, which provides output video (OUTV) information. The channel 102 may be any media or medium suitable for wired and/or wireless communications. The video encoder 101 includes encoding and decoding components and functions, including motion estimation which determines coded residuals including a block motion difference for the inter coding mode. In the embodiment illustrated, the video encoder 101 includes a memory 105 which receives the input video information, which is provided to an input of a video encoder 107. The input video information is provided in any suitable format, such as YUV or YCbCr 4:2:0 or the like. The YUV model defines a color space including luma (Y) information and color or chrominance (U and V) information. The YCbCr format defines a color space including luma (Y) and chrominance (Cb and Cr) information as known to those skilled in the art.

The video encoder 107 provides encoded video information EN to an output circuit 109, which provides the output bitstream OBTS. The output circuit 109 performs additional functions for converting the encoded information EN into the output bitstream OBTS, such as scanning, reordering, entropy encoding, etc., as known to those skilled in the art. The encoded information EN is also provided to the input of a video decoder 111 within the SVC video encoder 101, which decodes at least a portion of the encoded information EN and provides reconstructed information RN. The reconstructed information RN is stored back into the memory 105 and used as reference information by the video encoder 107 during the encoding process as further described below. The memory 105 is used to store information used during the encoding process, including, for example, input video frames and reconstructed video frames used as reference frames for encoding additional frames for each video stream.

The SVC video decoder 103 includes an input circuit 113, which performs inverse processing functions of the output circuit 109, such as inverse scanning, reordering, entropy decoding, etc., as known to those skilled in the art, and which provides encoded information EN′ to an input of a video decoder 115. The video decoder 115 decodes the encoded information EN′ and provides the output video information for storage or display. The video decoder 115 is coupled to a memory 117, which is used to store information used during the decoding process, including input video information and decoded frames used as reference frames for decoding additional frames for each video stream. The SVC video system 100 supports various layers of scalability, including temporal scalability, spatial scalability, complexity scalability and quality scalability. As previously described, temporal scalability generally refers to the number of frames per second (fps) of the video stream, such as 7.5 fps, 15 fps, 30 fps, etc. Although the memory 105 and the memory 117 are shown as separate memory portions of the encoder 101 and the decoder 103, it is appreciated that in one embodiment a common memory area of the SVC video system 100 may be used by both the encoder 101 and the decoder 103 (e.g., memories 105 and 117 are part of a common memory system of the SVC video system 100).

Examples of SVC video systems include any type of real time, low delay video applications, such as video phones, videoconferencing systems, video surveillance systems, etc. Scalability is particularly advantageous for disparate capabilities between two communicating video devices, such as differences in computational bandwidth and/or differences in display capabilities. For example, one videoconference device may be capable of displaying a higher number of frames per second (temporal scalability) or may have a higher resolution display (spatial scalability), such as CIF versus QCIF or the like.

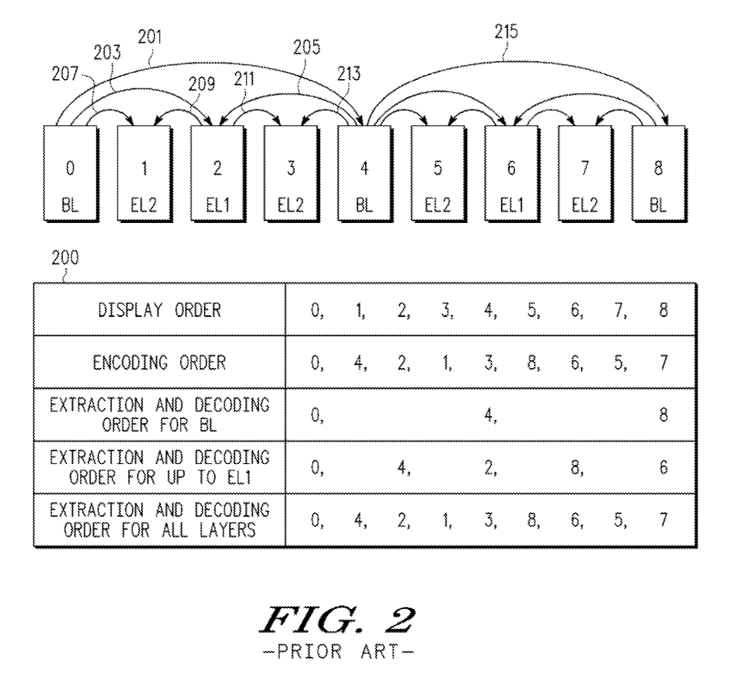

FIG. 2 is a figurative block diagram illustrating the conventional hierarchical B-frame coding structure used for H.264 and conventional SVC according to prior art for temporal scalability having a group of pictures (GOP) size of 4. The input video information is provided as a series of frames converted to the encoded video information EN according to a selected GOP size. The frame numbering as used herein applies to input frames, encoded frames, and decoded or reconstructed frames. In this manner, input frame 0 is encoded to provide encoded frame 0, which is decoded to provide reconstructed frame 0, and so on. Each GOP includes a base layer (BL) frame and one or more enhanced layer (EL) frames. A GOP size of four includes the base layer BL, a first enhanced layer EL1 and a second enhanced layer EL2. In accordance with the nomenclature used herein, encoded frames for the first enhanced layer EL1 are referred to as enhanced first layer frames, encoded frames for the second enhanced layer EL2 are referred to as enhanced second layer frames, and so on. The encoded frames are shown in display order, which is the order the frames are displayed on a screen or monitor. A first frame of the video sequence (numbered “0”) is encoded as a base layer frame labeled BL. The second frame (numbered “1”) is encoded as an enhanced second layer frame labeled EL2. The third frame (numbered “2”) is encoded as an enhanced first layer frame labeled EL1. The fourth frame (numbered “3”) is encoded as another enhanced second layer frame also labeled EL2. The fifth frame (numbered “4”) is encoded as another base layer frame labeled BL. The first frame 0 is an IDR-frame (instantaneous decoding refresh frame) or the like and is provided before the first GOP. The first GOP includes the next four frames 1-4. The second GOP includes four frames numbered 5-8, and so on. The GOPs in the encoded video sequence repeat in the same manner until the next IDR-frame as understood by those skilled in the art.

A table 200 lists the frames 0-8 in display order, encoding order, extraction and decoding order for displaying only the base layer BL, extraction and decoding order for displaying up to the first enhanced layer EL1, and extraction and decoding order for displaying all layers or up to the second enhanced layer EL2. The display order is 0, 1, 2, . . . , 8 for the first 9 frames illustrated assuming all layers are displayed. The encoding order for conventional hierarchical B-frame coding, however, does not follow the display order. The first frame 0 of the input video information is encoded first as a base layer IDR-frame 0, and a reconstructed frame 0 is stored in the memory. For purposes of illustration, reference is made to the SVC video system 100 configured in a conventional mode according the conventional hierarchical B-frame coding structure. In this manner, the first frame of the input video information is stored in the memory 105 and provided to the video encoder 107, which provides an encoded base layer frame 0 within the encoded information EN. The video decoder 111 decodes the encoded base layer frame 0 and provides the reconstructed frame 0 as part of the reconstructed information RN, in which the reconstructed frame 0 is stored back into the memory 105.

The base layer frame 4 is encoded next, causing a significant delay for loading the raw input video frames 1, 2, 3 and 4 into the memory 105 before the encoding process for frame 4 is initiated. The reconstructed frame 0 stored in the memory 105 is used as a reference frame while frame 4 is encoded according to forward prediction as indicated by arrow 201. The encoded frame 4 is decoded by the video decoder 111 to provide a reconstructed frame 4, which is stored in the memory 105. According to bidirectional prediction and as indicated by arrows 203 and 205, the reconstructed base layer frames 0 and 4 are used to encode frame 2. The encoded frame 2 is then decoded by the video decoder 111 to provide a reconstructed frame 2, which is stored in the memory 105. As represented by arrows 207 and 209, the reconstructed frames 0 and 2 are used by the video encoder 107 to encode frame 1. As indicated by arrows 211 and 213, the reconstructed frames 2 and 4 are used to encode frame 3. After the first five frames 0-4 are encoded, the process is repeated for the next four frames 5-8. As shown, reconstructed frame 4 is used as a reference frame for encoding the next base layer frame 8 as indicated by arrow 215, and the encoding process is repeated.

The conventional hierarchical B-frame coding structure results in significant coding delay and inefficient use of coding memory space which reduces overall efficiency of temporal scalability for SVC. After frame 0 is encoded, the input video frames 1-4 are loaded into the memory 105 (if not already stored) before initiating encoding of the next base layer frame 4. Frame 4 is encoded and reconstructed frame 4 is stored into the memory 105 since used as a reference frame for encoding other frames in the first GOP. The reconstructed frames 0 and 4 are stored in the memory 105 and used for encoding frame 2, and then reconstructed frame 2 is also stored in the memory 105 since used as a reference frame for encoding enhanced layer frames 1 and 3. In this manner, reconstructed frames 0, 2 and 4 are stored in the memory 105 and used to encode enhanced layer frames 1 and 3. After frame 2 is encoded, frame 1 is finally encoded using reconstructed frames 0 and 2 as reference frames. Then frame 3 is encoded using reconstructed frames 2 and 4 as reference frames. It is appreciated that a significant delay occurs waiting for encoding of frames 4 and 2 before encoding of frame 1 is initiated. Frame 3 is then encoded to complete encoding for the first GOP. A similar delay occurs for encoding the next GOP including frames 5-8. Frames 8 and 6 are encoded before encoding begins for the next frame 5 according to display order. It is appreciated that because of the conventional coding order, an encoding delay occurs in each GOP of the video sequence.

In one embodiment, the memory 105 includes an input memory for the “raw” video input frames and a separate reference memory for storing reconstructed frames used as reference frames for encoding other frames for prediction. In this embodiment, the input memory stores at least input frames 0-4 and the reference memory stores at least three frames including frames 0, 2 and 4 used as reference frames. In another embodiment, the reconstructed frames replace the input frames within the same memory 105 so that a separate reference frame memory is avoided. Nonetheless, the memory 105 has to include sufficient space to store at least input video frames 0-4 to begin the encoding process if using the conventional hierarchical B-frame coding structure.

The encoded frames are incorporated into the OBTS by the encoder 101 and provided to the channel 102. The decoder 103 receives frames encoded in a similar manner via the IBST from the channel 102. Frames 0-8 are also used to illustrate the decoding process, which are retrieved from the input bitstream IBTS as encoded frames. The SVC video decoder 103 is used to illustrate the conventional hierarchical B-frame coding structure in a similar manner. For the GOP size of four, the SVC video decoder 103 may be configured to display only the base layer frames, including frames 0, 4, 8, etc., up to the first enhanced layer EL1 including frames 0, 2, 4, 6, 8, etc., or up to the second enhanced layer EL2 including each of the frames 0-8. As understood by those skilled in the art, temporal scalability is achieved by selecting the number of frames to be displayed in a given time frame. In SVC, the frame rate is selected by selecting a corresponding layer to be displayed. For example, if the encoded input video information is provided as 30 frames per second (fps), then all frames are displayed at 30 fps, only the base layers are displayed to scale down to 7.5 fps, and only up to the first enhanced layer frames are displayed to scale down to 15 fps.

The first encoded frame 0 is received, extracted, decoded by the video decoder 115 and stored within the memory 117 as a decoded frame 0. After being decoded, the decoded frame 0 is available for display. If the video decoder 115 is configured to only display the base layer, then the next three encoded frames 1, 2 and 3 are ignored. The decoded frame 0 remains stored in the memory 117 and is used as a reference frame for decoding the next base layer frame 4. After frame 4 is decoded, it is available for display and the decoded frame 4 is stored in the memory 117 and used as a reference frame for the next base layer frame 8. If only the base layer is being displayed, then there is no coding delay.

If the decoder 103 is configured to display up to the first enhanced layer EL1, then there is a one-frame coding delay for each GOP. A one-frame coding delay is incurred waiting for the decoding of the base layer frame 4 used as a reference frame for decoding the first enhanced layer frame 2, and then a one-frame coding delay is incurred waiting for the decoding of the base layer frame 8 used as a reference frame for decoding the next enhanced layer frame 6, and so on. Furthermore, the decoded frames 0 and 4 remain in the memory 117 and are used for decoding frame 2, and then the decoded frames 4 and 8 remain in the memory 117 to be used for decoding frame 6, and so on. It is appreciated that the memory 117 has to have sufficient memory space for storing at least two decoded frames for prediction during bidirectional decoding.

If the decoder 103 is configured to display up to the second enhanced layer EL2 for GOP size of 4, then there is a three-frame coding delay for each GOP. There is a three-frame coding delay since frames 4, 2 and 1 are decoded first before the second frame 1 is available for display by the decoder 103. Frame 3 is then decoded using decoded frames 2 and 4 as reference frames. Thereafter, there is a three-frame decoding delay for each subsequent GOP. For example, frames 8, 6 and 5 are decoded before frame 5 is available for display, and so on. The memory 117 is configured to have sufficient memory space for storing at least three decoded frames used as reference frames for decoding remaining frames for each GOP, so that the memory 117 stores at least four frames at a time. For example, decoded frames 0, 2 and 4 are stored and used as reference frames for decoding both of the second enhanced layer frames 1 and 3 in the first GOP, and then decoded frames 4, 8 and 6 are stored and used as reference frames for decoding the second enhanced layer frames 5 and 7 in the second GOP, and so on.

The conventional hierarchical B-frame coding structure may be implemented to use only one reference frame and limited to forward prediction rather than bidirectional prediction. The coding (encoding and decoding) order, however, is the same resulting in the same coding delays as the bidirectional prediction embodiment for each of the enhanced layers. The memory 105 of the SVC video encoder 101 is still configured to store at least the first 5 frames of input video frames. The memory 117 of the SVC video decoder 103 may be reduced to store three decoded frames at a time.

The coding delay becomes more prevalent in certain applications. A significant round-trip coding delay occurs in a bidirectional application, such as a video conference application between two locations. In a video conference application, the encoding and decoding delays accumulate in both directions, potentially causing significant delay in communications. The coding delays are added to the round-trip delay through the channel 102. As an example, assume a person at a first location asks a person at a second location a question during the video conference application. The person asking the question at the first location must wait for the full round-trip coding delay before hearing the response from the second person at the second location.

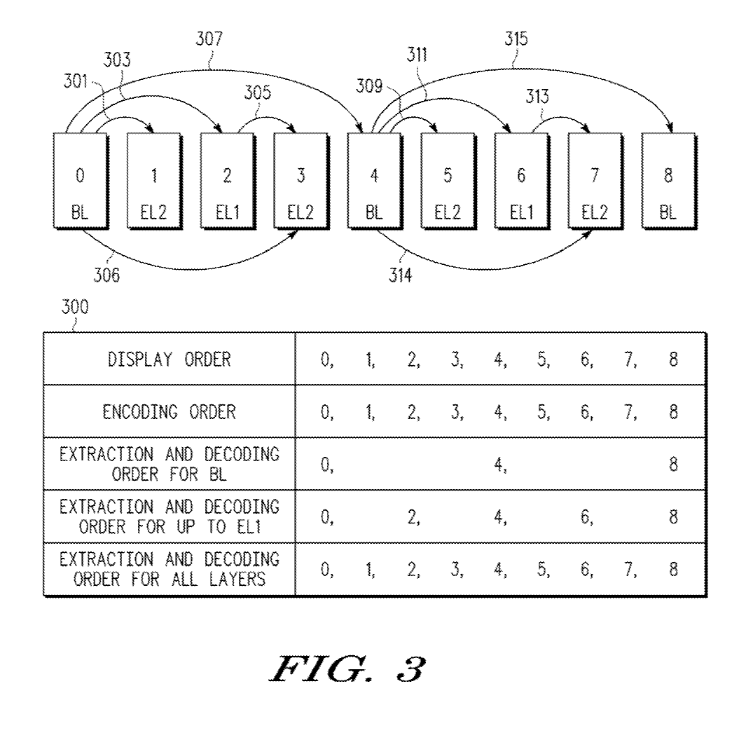

FIG. 3 is a figurative block diagram illustrating a coding structure according to an exemplary embodiment for implementing temporal scalability for low delay SVC for a GOP size of 4. The frames 0-8 are again shown ordered in display order. A table 300 lists the display order, encoding order, extraction and decoding order for displaying only the base layer, extraction and decoding order for displaying up to the first layer, and extraction and decoding order for displaying up to the second layer. In this case, the frames are encoded in the same order as the display order using only forward prediction. And furthermore, the frames are extracted and decoded in the same order as the display order regardless of which enhanced layer is displayed. The SVC video system 100 is used to illustrate a coding structure according to an exemplary embodiment for implementing temporal scalability for low delay SVC.

Input video information is provided to the memory 105 and to the video encoder 107. Frame 0 is encoded by the video encoder 107 and provided as an encoded frame 0 within the encoded information EN. The video decoder 111 decodes the encoded frame 0 and provides a reconstructed frame 0 as part of the reconstructed information RN. The reconstructed frame 0 is stored in the memory 105. Frame 1 is encoded next using the reconstructed frame 0 as a reference frame as indicated by arrow 301. The memory 117 temporarily stores both frames 0 and 1 while frame 1 is being encoded, but frame 1 may be overwritten in memory once encoded. Frame 2 is encoded next using the reconstructed frame 0 as a reference frame as indicated by arrow 303. After frame 2 is encoded, it is decoded by the video decoder 111 to provide a reconstructed frame 2. During the decoding of encoded frame 2, the reconstructed base layer frame 0 stored in the memory 105 is used as a reference frame for reconstructing frame 2. The reconstructed frame 2 is stored in the memory 105 and temporarily remains stored since as a reference frame for next frame 3. Frame 3 is encoded next using the reconstructed frame 2 as a single reference frame as indicated by arrow 305. In an alternative embodiment, frame 3 is encoded using both the reconstructed frame 2 and the reconstructed frame 0 as indicated by arrows 305 and 306. There is no additional cost in memory storage using frame 0 as an additional reference frame since it remains stored in the memory 105 for use as a reference frame for encoding frame 4. Frame 4 is encoded next using the reconstructed frame 0 as a reference frame as indicated by arrow 307. After frame 4 is encoded, it is decoded by the video encoder 107 using reconstructed base layer frame 0 as a reference frame to provide a reconstructed frame 4. Reconstructed frame 4 is then stored in the memory 105.

Reconstructed frame 4 temporarily remains in the memory 105 for use as a reference frame for encoding the next GOP including frames 5-8. Reconstructed frame 4 is used as a reference frame for encoding frame 5 as indicated by arrow 309, and reconstructed frame 4 is used as a reference frame for encoding frame 6 as indicated by arrow 311. Encoded frame 6 is decoded using reconstructed frame 4 as a reference frame, and reconstructed frame 6 is stored in the memory 105. Reconstructed frame 6 is used as a reference frame for encoding frame 7 as indicated by arrow 313, and reconstructed frame 4 is used as a reference frame for encoding frame 8 as indicated by arrow 315. Encoded frame 8 is decoded to provide a reconstructed frame 8, which is stored in the memory 105. In one embodiment, reconstructed frame 4 is used as another reference frame for encoding frame 7 as indicated by arrow 314. Operation repeats in this manner. It is noted that the memory 105 may be configured for storing up to only three frames during the encoding process.

The encoded frames are incorporated into the OBTS by the encoder 101 and provided to the channel 102. The SVC video decoder 103 receives encoded frames in a similar manner via the IBST from the channel 102. The input bitstream IBTS is processed through the input circuit 113 and provided as encoded information EN′. The first frame 0 is received, extracted, decoded by the video decoder 115 and stored within the memory 117 as a decoded frame 0 in a similar manner as previously described. After being decoded, the decoded frame 0 is immediately available for display. If the decoder 103 is configured to display only the base layer, then the next three encoded frames 1, 2 and 3 are ignored. The decoded frame 0 remains stored in the memory 117 and is used as a reference frame for decoding the next base layer frame 4 (arrow 307). After frame 4 is decoded, it is immediately available for display. The decoded frame 4 is stored in the memory 117 and used as a reference frame for the next base layer frame 8 as indicated by arrow 315, in which the frames 5-7 are ignored. There is no coding delay and the memory 117 may be configured for storing up to only two frames at a time.

There is still no coding delay if the SVC video decoder 103 is configured to display only up to the first enhanced layer EL1. The decoded frame 0 stored in the memory 117 is used as a reference frame by the video decoder 115 for decoding frames 2 and 4 (arrows 303 and 307). The encoded frames 1 and 3 are ignored, and frames 2 and 4 are immediately available for display after being decoded. The decoded frame 4 remains in the memory 117 and is used as a reference frame for decoding frames 6 and 8 (arrows 311 and 315). The encoded frames 5 and 7 are ignored, and frames 6 and 8 are immediately available for display after being decoded. Operation repeats in this manner for subsequent GOPs. There is no coding delay for displaying up to EL 1 since the frames are decoded in order and only forward prediction is used. The decoded frames 2 and 6 are not used as reference frames (since frames 3 and 7 are ignored if displaying only up to layer EL1) so that it is not stored in a reference memory portion of the memory 117. The memory 117 only stores up to two frames at a time, including decoded frame 0 or 4 and 1 additional frame being decoded. It is appreciated that the memory 117 stores only two frames at a time to improve memory efficiency.

There is still no coding delay even if the decoder 103 is configured to display up to the second enhanced layer EL2. The first base layer frame 0 is decoded and stored in the memory 117 and used as a reference frame for frames 1 and 2 in one embodiment (arrows 301 and 303) or frames 1, 2 and 3 in another embodiment (arrows 301, 303 and 306). As soon as each frame is decoded in display order, it is immediately available for display. The decoded frame 2 remains stored in memory 117 and used as a reference frame for decoding frame 3 (arrow 305), and may then be erased or overwritten within the memory 117. In this case, the memory 117 may be configured for storing up to only three frames at a time for each GOP (e.g., decoded frames 0 and 2 and one additional frame being decoded). It is noted that decoded frame 0 remains stored in the memory 117 until after frame 4 is decoded, and then may be removed from the memory 117. Decoded frame 4 is stored in the memory 117 and used as a reference frame for decoding frames 5, 6 and 8 (in one embodiment) or frames 5, 6, 7 and 8 (in another embodiment) in the second GOP, and so on.

The coding structure illustrated in FIG. 3 provides significant advantages as compared to the conventional hierarchical B-frame coding structure for low-delay temporal scalability. Since the frames are encoded in order using forward prediction and since at least one enhanced layer frame (reconstructed) is used as a reference frame for encoding a subsequent input video frame as another enhanced layer frame, there are no encoding delays. The memory 105 at the encoder 101 may be reduced from storing five frames to storing three frames. Also, there are no decoding delays regardless of which layer is to be displayed since the frames are decoded in order, only forward prediction is used, and since at least one enhanced layer frame (decoded) is used as a reference frame. The memory 117 at the decoder 103 may be reduced from storing up to five frames for bidirectional decoding to storing up to only three frames. In general, coding delays are minimized since frames are coded in order, only forward prediction is used, and enhanced layer frames (reconstructed or decoded) are used as reference frames.

It is appreciated by those of ordinary skill in the art that decoded frames at the SVC video decoder 103 are intended to be identical or substantially identical to reconstructed frames at the SVC video encoder 101 to ensure equivalency of video information between the encoder and the decoder. The video decoder 111 operates in substantially the same manner when decoding the encoded information EN using reconstructed information RN stored in the memory 105 as the video decoder 115 when decoding the encoded information EN′ using decoded information stored in the memory 117. In this manner, the decoding process performed by the SVC video encoder 101 is substantially the same as the decoding process performed by the SVC video decoder 103 as understood by those skilled in the art.

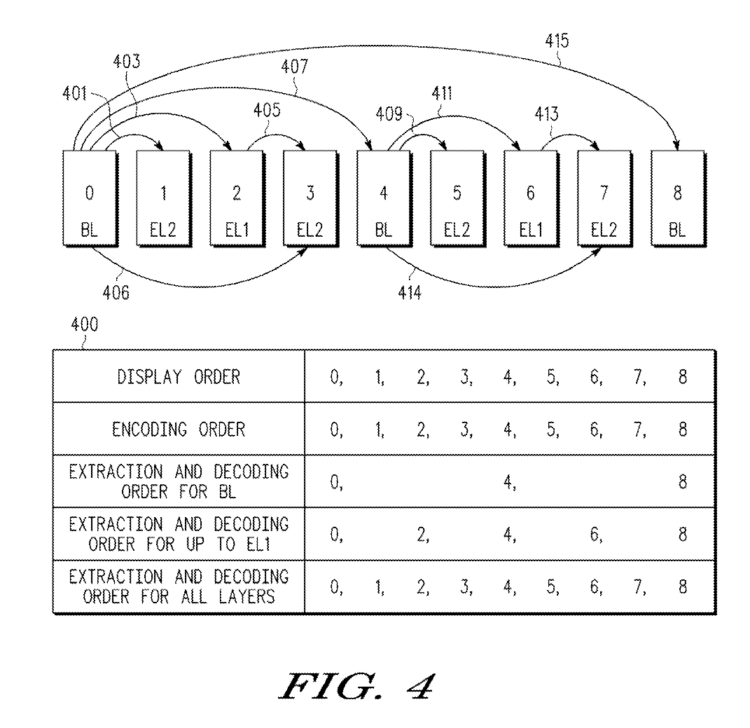

FIG. 4 is a figurative block diagram illustrating a coding structure according to an exemplary embodiment for implementing temporal scalability for low delay SVC for a GOP size of 8. Only the first frame 0 and the first GOP including frames 1-8 are shown in display order. Again, the frames are coded in the same order as the display order using only forward prediction for both encoding and decoding. During the coding process for each GOP, at least one reconstructed (during encoding) or decoded (during decoding) enhanced layer frame is used as a reference frame. In this case, frames 0 and 8 are base layer frames labeled BL, frames 1, 3, 5 and 7 are enhanced layer 3 frames labeled EL3, frames 2 and 6 are enhanced layer 2 frames labeled EL2, and frame 4 is an enhanced layer 1 frame labeled EL1. In this manner, the base layer BL includes frames 0 and 8, up to the first enhanced layer EL1 includes frames 0, 4 and 8, up to the second enhanced layer EL2 includes frames 0, 2, 4, 6 and 8, and up to the third enhanced layer EL3 includes all frames 0-8.

The first frame 0 is encoded to provide an encoded base layer frame 0, which is decoded to provide a reconstructed frame 0 stored in the memory 105. Frame 1 is encoded next as an encoded enhanced third layer frame 1 using the reconstructed frame 0 as a reference frame as indicated by arrow 401. Frame 2 is encoded next as an encoded enhanced second layer frame 2 using the reconstructed first frame 0 as a reference frame as indicated by arrow 403. Encoded frame 2 is decoded using frame 0 as a reference frame and reconstructed frame 2 is stored in the memory 105 as another reference frame. In one embodiment, frame 3 is encoded next as another encoded enhanced third layer frame using the reconstructed frame 2 as a reference frame as indicated by arrow 405. In an alternative embodiment, frame 3 is encoded using both the reconstructed frame 2 and the reconstructed frame 0 as indicated by arrows 405 and 406. Frame 4 is decoded using reconstructed frame 0 as a reference frame as indicated by arrow 407 to provide reconstructed frame 4, which is stored in the memory 105. At this point, reconstructed frames 0 and 4 remain in the memory 105 for use as reference frames for encoding subsequent frames. Reconstructed frame 4 is used as a reference frame for encoding frames 5 and 6 in one embodiment as indicated by arrows 409 and 411, respectively. In another embodiment, reconstructed frame 4 is also used as a reference frame for encoding frame 7 as indicated by arrow 414. It is noted that the reconstructed frame 0 may also be used as a reference frame for coding frames 5, 6, and 7 in an alternative embodiment. In this manner, for a GOP of 8, an enhanced layer frame is used as a reference frame for encoding multiple subsequent enhanced layer frames. Frame 6 is decoded using reconstructed frame 4 as a reference frame and reconstructed frame 6 is stored in the memory 105 and used as a reference frame for encoding frame 7 as indicated by arrow 413. The next frame 8 is encoded next as a base layer frame using reconstructed frame 0 as a reference frame as indicated by arrow 415. Operation repeats in this manner.

The decoding process is substantially similar and there is no coding delay. The SVC video decoder 103 receives frames encoded in a similar manner via the input bitstream IBST from the channel 102. The first frame 0 is received, extracted, decoded and stored within the memory 117 as a decoded frame 0 in a similar manner as previously described. After being decoded, the decoded frame 0 is available for display. If the SVC video decoder 103 is configured to display only the base layer, then the next seven encoded frames 1-7 are ignored and decoded frame 0 is used as a reference frame for decoding the next base layer frame 8 (arrow 415). If the decoder 103 is configured to display only up to EL1, then encoded frames 1-3 are ignored and the decoded frame 0 is used as a reference frame for decoding frame 4 (arrow 407). The next three frames 5-7 are ignored, decoded frame 4 may be removed from the memory 117, and decoded frame 0 is used as a reference frame for decoding frame 8 (arrow 415).

If the SVC video decoder 103 is configured to display only up to EL2, then the encoded frame 1 is ignored and the decoded frame 0 is used as a reference frame for decoding frame 2 (arrow 403). Encoded frame 3 is ignored and decoded frame 0 is used as a reference frame for decoding frame 4 (arrow 407). Frame 5 is ignored and decoded frame 4 remains in the memory 117 and used as a reference frame for decoding frame 6 (arrow 411). Finally, decoded frame 0 is used as a reference frame for decoding frame 8 (arrow 415). If the decoder 103 is configured to display up to EL3, then decoded frame 0 is used to decode frames 1 and 2 in one embodiment (arrows 401 and 403) and or frames 1-3 in another embodiment (arrows 401, 403 and 406). Decoded frame 2 is used as a reference frame for decoding frame 3 (arrow 405), and decoded frame 0 is used as the reference frame for decoding frame 4 (arrow 407). Decoded frame 4 remains in the memory 117 and is used to decode frames 5 and 6 in one embodiment (arrows 409 and 411) and frame 7 in another embodiment (arrow 414). Finally, decoded frame 0 is used as a reference frame for decoding frame 8 (arrow 415). It is noted that the decoded frame 0 may also be used as a reference frame for coding frames 5, 6, and 7 in an alternative embodiment.

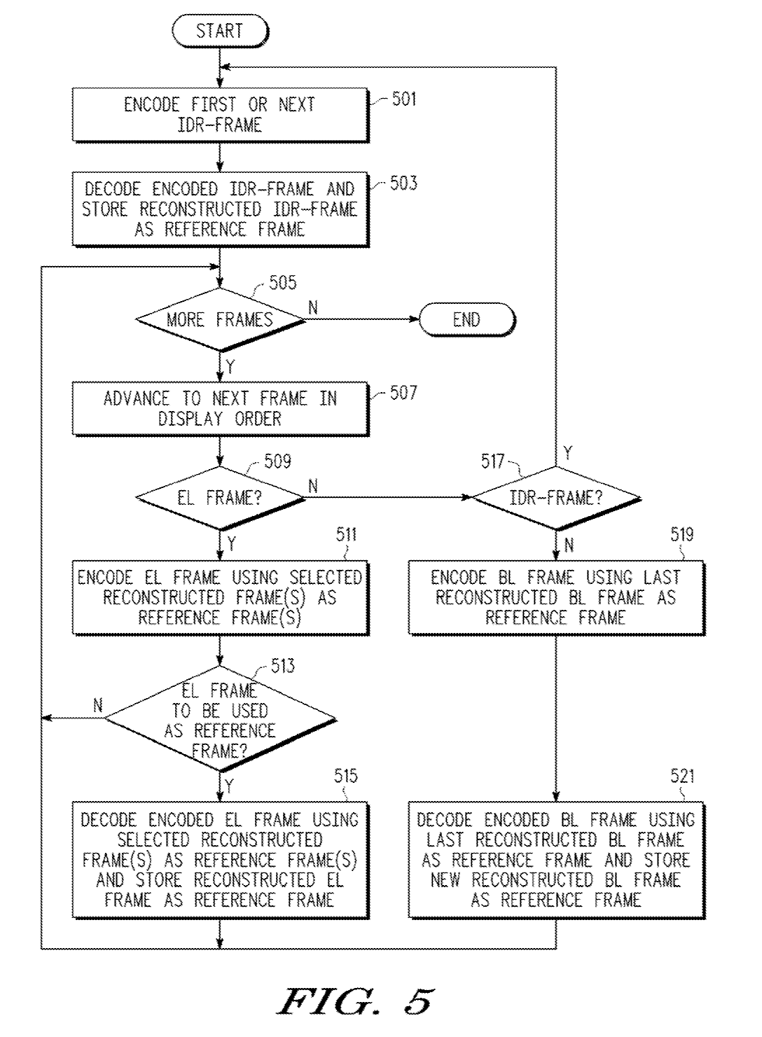

FIG. 5 is a flowchart diagram illustrating exemplary operation of the SVC video encoder 101 according to an exemplary embodiment. At first block 501 the first frame of the input video sequence, which is typically an IDR-frame, is encoded. At next block 503, the encoded IDR-frame is decoded and the reconstructed IDR-frame is stored as a reference frame. At next block 505, it is queried whether there are additional frames. If so, operation proceeds to block 507 in which the encoder advances to the next frame in display order. At next block 509, it is queried whether the next frame in display order is an enhanced layer (or EL) frame. After the first IDR-frame, the next frame in the video sequence is an EL frame, so operation advances to block 511 in which the EL frame is encoded using one or more selected reconstructed frames as reference frames. In the first iteration, the initial IDR-frame (e.g., frame 0 shown in FIG. 3) is the sole reference frame used as a reference frame for encoding the first EL frame (e.g., frame 1 in FIG. 3). In subsequent iterations, additional reference frames may be used. As shown in FIG. 3, frame 3 is encoded using frame 2 as the sole reference frame in one embodiment or using frames 0 and 2 in another embodiment. At next block 513, it is queried whether the just encoded EL frame is to be used as a reference frame for encoding subsequent frames. If not, operation loops back to block 505 for more frames. If the just encoded EL frame is to be used as a reference frame (e.g., frames 2, 4, and 6 in FIG. 4), then operation advances instead to block 515 in which the just encoded EL frame is decoded using selected reconstructed frame(s) as reference frame(s) and the reconstructed EL frame is stored for use as a reference frame. Operation then returns to block 505 to query whether there are additional frames in the video sequence. Operation loops between blocks 505-515 for encoding sequential enhanced layer frames in display order.

If the next frame in display order is not an EL frame as determined at block 509, then operation advances instead to block 517 in which it is queried whether the next frame is an IDR-frame. If so, operation returns to blocks 501 and 503 in which the next IDR-frame is encoded and then decoded and stored. In this manner, each IDR-frame in the video sequence is encoded and decoded and the corresponding reconstructed IDR-frames are stored as reference frames. If the next frame is not an IDR-frame, then it is a base layer (BL) frame and operation proceeds instead to block 519 at which the BL frame is encoded using the last reconstructed BL frame as a reference frame. Operation then advances to block 521 in which the newly encoded BL frame is decoded using the last reconstructed BL frame as a reference frame and the newly reconstructed BL frame is stored for use as a reference frame for the subsequent GOP. Operation then returns to block 505 to query whether there are additional frames in the video sequence. If not, operation is completed.

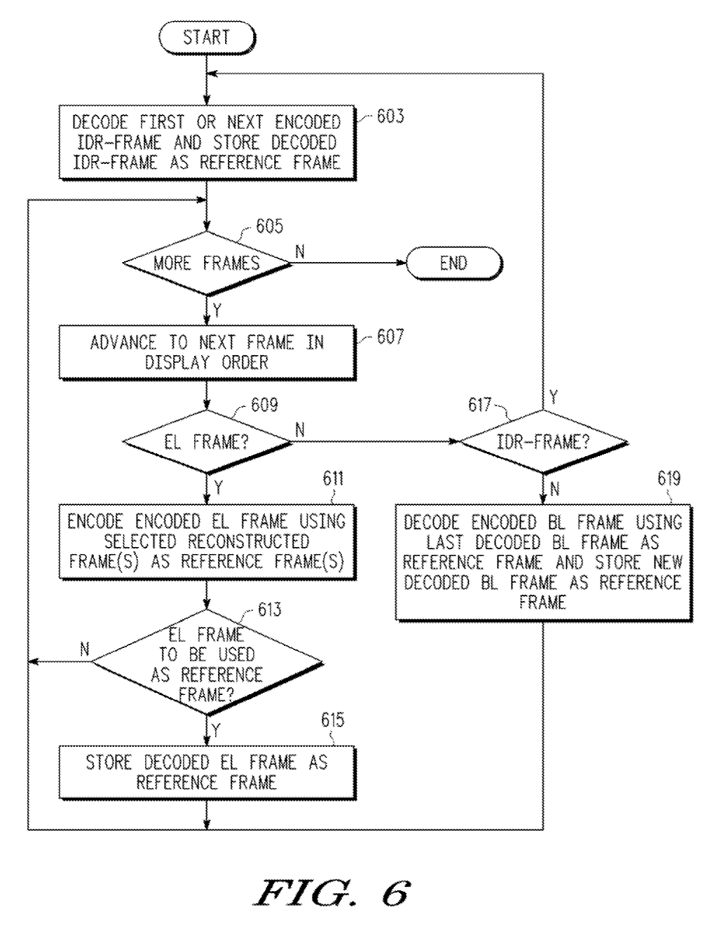

FIG. 6 is a flowchart diagram illustrating exemplary operation of the SVC video decoder 103 according to an exemplary embodiment. The decoding process performed by the decoder 103 is substantially similar to the decoding process performed within the encoder 101. At first block 603, the first encoded IDR-frame is decoded and the decoded IDR-frame is stored as a reference frame. At next block 605, it is queried whether there are additional frames. If so, operation proceeds to block 607 in which the decoder advances to the next frame in display order. At next block 609, it is queried whether the next frame in display order in an enhanced layer (or EL) frame. After the first IDR-frame, the next frame in the encoded video sequence is an EL frame, so operation advances to block 611 in which the encoded EL frame is decoded using one or more selected reconstructed frames as reference frames. At next block 613, it is queried whether the just decoded EL frame is to be used as a reference frame for decoding subsequent frames. If not, operation loops back to block 605 for more frames. If the just decoded EL frame is to be used as a reference frame for decoding subsequent frames, then operation advances instead to block 615 in which the just decoded EL frame is stored for use as a reference frame. Operation then returns to block 605 to query whether there are additional frames in the encoded video sequence. Operation loops between blocks 605-615 for decoding sequential enhanced layer frames in display order.

If the next frame in display order is not an EL frame as determined at block 609, then operation advances instead to block 617 in which it is queried whether the next frame is an IDR-frame. If so, operation returns to block 603 in which the next IDR-frame is decoded and then stored. In this manner, the IDR-frames in the video sequence are decoded and stored as reference frames. If the next frame is not an IDR-frame, then it is a base layer (BL) frame and operation proceeds instead to block 619 at which the encoded BL frame is decoded using the last decoded BL frame as a reference frame, and the newly decoded BL frame is stored for use as a reference frame for the subsequent GOP. Operation then returns to block 605 to query whether there are additional frames in the video sequence. If not, operation is completed.

A method of processing video information according to one embodiment includes receiving encoded video information including an encoded base layer frame and encoded enhanced layer frames for providing temporal scalability, decoding the encoded video information in display order, and using a decoded first enhanced layer frame as a reference frame for decoding a second enhanced layer frame for forward prediction. Processing the video information in display order and using a decoded enhanced layer frame as a reference frame for processing another enhanced layer frame for forward prediction reduces coding latency for achieving temporal scalability for low delay scalable video coding. Also, coding memory space may be reduced as compared to bidirectional prediction coding since the number of reference frames used for coding may be reduced.

The method may include decoding first, second and third encoded enhanced layer frames to provide corresponding first, second and third decoded enhanced layer frames, and using the second decoded enhanced layer frame as a reference frame for decoding the third encoded enhanced layer frame. The method may further include decoding the encoded base layer frame to provide a decoded base layer frame, and using the decoded base layer frame as another reference frame for decoding the third encoded enhanced layer frame. The method may include using a decoded enhanced first layer frame as a reference frame for decoding an encoded enhanced second layer frame. The method may include using a decoded enhanced second layer frame as a reference frame for decoding an encoded enhanced third layer frame.

The method may further include encoding input video information in display order to provide the encoded video information, decoding a first encoded enhanced layer frame to provide a first reconstructed enhanced layer frame, and using the first reconstructed enhanced layer frame as a reference frame for encoding a second enhanced layer frame.

The method may further include encoding first, second, third and fourth input video frames in display order to provide the encoded video information which includes the encoded base layer frame and first, second and third encoded enhanced layer frames, decoding the second encoded enhanced layer frame to provide a corresponding reconstructed enhanced layer frame, and using the reconstructed enhanced layer frame as a reference frame for encoding the fourth input video frame. The method may also include decoding the encoded based layer frame to provide a reconstructed base layer frame and using the reconstructed base layer frame as another reference frame for decoding the fourth input video frame.

A method of processing video information according to another embodiment includes encoding input video frames in display order, reconstructing at least one encoded enhanced layer frame, and using a reconstructed enhanced layer frame as a reference frame for encoding a subsequent input video frame as an encoded enhanced layer frame. The method may include decoding an encoded enhanced first layer frame to provide a reconstructed enhanced first layer frame and using the reconstructed enhanced first layer frame as a reference frame for encoding the subsequent input video frame as an encoded enhanced second layer frame. The method may further include decoding an encoded base layer frame to provide a reconstructed base layer frame and using the reconstructed base layer frame as another reference frame for encoding the subsequent input video frame as an encoded enhanced second layer frame. The method may include decoding an encoded enhanced second layer frame to provide a reconstructed enhanced second layer frame and using the reconstructed enhanced second layer frame as a reference frame for encoding the subsequent input video frame as an encoded enhanced third layer frame.

The method may include providing an encoded base layer frame, an encoded first enhanced layer frame and an encoded second enhanced layer frame, decoding the encoded base layer frame to provide a reconstructed base layer frame, and decoding the encoded first enhanced layer frame to provide a reconstructed first enhanced layer frame. The method may include using the reconstructed first enhanced layer frame as a reference frame while providing the encoded second enhanced layer frame. The method may include using the reconstructed base layer frame as another reference frame while providing the encoded second enhanced layer frame.

A scalable video system according to one embodiment includes a video decoder and a memory. The video decoder decodes encoded video frames in display order and provides decoded video frames which includes a decoded base layer frame, a first decoded enhanced layer frame and a second decoded enhanced layer frame. The memory stores the decoded base layer frame and the first decoded enhanced layer frame. The video decoder uses the first decoded enhanced layer frame as a reference frame while decoding the second decoded enhanced layer frame.

The scalable video system may include an input circuit which receives an input bitstream from a communication channel, and which performs inverse processing functions to convert the input bitstream to the encoded video frames.

The video decoder may be configured to store into the memory decoded base layer frames and any decoded enhanced layer frame which is to be used as a reference frame for decoding another encoded enhanced layer frame.

The scalable video system may further include a video encoder which encodes input video information in display order and which provides the encoded video frames. In one embodiment, the video encoder uses the first decoded enhanced layer frame as a reference frame while encoding another enhanced layer frame.

Although the invention is described herein with reference to specific embodiments, various modifications and changes can be made without departing from the scope of the present invention as set forth in the claims below. It should be understood that all circuitry or logic or functional blocks described herein may be implemented either in silicon or another semiconductor material or alternatively by software code representation of silicon or another semiconductor material. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

1. A method of processing video information, comprising:
receiving encoded video information which comprises an encoded base layer frame and a plurality of encoded enhanced layer frames providing temporal scalability;
decoding the encoded video information in display order; and
during said decoding, using a decoded first enhanced layer frame as a reference frame for decoding a second enhanced layer frame for forward prediction.

2. The method of claim 1, wherein said decoding comprises:
decoding first, second and third encoded enhanced layer frames to provide corresponding first, second and third decoded enhanced layer frames; and
using the second decoded enhanced layer frame as a reference frame for decoding the third encoded enhanced layer frame.

3. The method of claim 2, further comprising not using the second decoded enhanced layer frame as a reference frame for decoding the first encoded enhanced layer frame.

4. The method of claim 2, further comprising;
decoding the encoded base layer frame to provide a decoded base layer frame; and
using the decoded base layer frame as another reference frame for decoding the third encoded enhanced layer frame.

5. The method of claim 1, wherein the encoded video information comprises an encoded enhanced first layer frame and at least one encoded enhanced second layer frame, and wherein said using a decoded first enhanced layer frame as a reference frame for decoding a second enhanced layer frame comprises using a decoded enhanced first layer frame as a reference frame for decoding an encoded enhanced second layer frame.

6. The method of claim 5, wherein the encoded video information further comprises at least one enhanced third layer frame, and wherein said using a decoded first enhanced layer frame as a reference frame for decoding a second enhanced layer frame comprises using a decoded enhanced second layer frame as a reference frame for decoding an encoded enhanced third layer frame.

7. The method of claim 1, further comprising:
encoding input video information in display order to provide the encoded video information;
wherein said decoding comprises decoding a first encoded enhanced layer frame to provide a first reconstructed enhanced layer frame; and
during said encoding, using the first reconstructed enhanced layer frame as a reference frame for encoding a second enhanced layer frame.

8. The method of claim 1, further comprising:
encoding first, second, third and fourth input video frames in display order to provide the encoded video information comprising the encoded base layer frame and the plurality of encoded enhanced layer frames including first, second and third encoded enhanced layer frames;
wherein said decoding comprises decoding the second encoded enhanced layer frame to provide a corresponding reconstructed enhanced layer frame; and
during said encoding, using the reconstructed enhanced layer frame as a reference frame for encoding the fourth input video frame.

9. The method of claim 8, wherein said decoding comprises decoding the encoded base layer frame to provide a reconstructed base layer frame and wherein said encoding further comprises using the reconstructed base layer frame as another reference frame for decoding the third input video frame.

10. A method of processing video information, comprising:
encoding input video frames in display order;
reconstructing at least one encoded enhanced layer frame; and
during said encoding, using a reconstructed enhanced layer frame as a reference frame for encoding a subsequent input video frame as an encoded enhanced layer frame.

11. The method of claim 10, wherein:
said encoding comprises encoding first, second, third and fourth input video frames to provide an encoded base layer frame and encoded first, second and third enhanced layer frames, respectively;
wherein said reconstructing comprises reconstructing the encoded first, second and third enhanced layer frames to provide reconstructed first, second and third enhanced layer frames, respectively; and
wherein said using comprises using the reconstructed second enhanced layer frame as a reference frame while encoding the fourth input video frame and not using the reconstructed second enhanced layer frame as a reference frame while encoding the second input video frame.

12. The method of claim 10, wherein said reconstructing comprises decoding an encoded enhanced first layer frame to provide a reconstructed enhanced first layer frame and wherein said using a reconstructed enhanced layer frame as a reference frame comprises using the reconstructed enhanced first layer frame as a reference frame for encoding the subsequent input video frame as an encoded enhanced second layer frame.

13. The method of claim 12, further comprising decoding an encoded base layer frame to provide a reconstructed base layer frame and using the reconstructed base layer frame as another reference frame for encoding the subsequent input video frame as an encoded enhanced second layer frame.

14. The method of claim 12, wherein said reconstructing comprises decoding an encoded enhanced second layer frame to provide a reconstructed enhanced second layer frame and wherein said using a reconstructed enhanced layer frame as a reference frame comprises using the reconstructed enhanced second layer frame as a reference frame for encoding the subsequent input video frame as an encoded enhanced third layer frame.

15. The method of claim 10, further comprising:
said encoding input video frames comprising providing an encoded base layer frame, an encoded first enhanced layer frame and an encoded second enhanced layer frame;
decoding the encoded base layer frame to provide a reconstructed base layer frame; and
wherein said reconstructing at least one encoded enhanced layer frame comprises decoding the encoded first enhanced layer frame to provide a reconstructed first enhanced layer frame.

16. The method of claim 15, wherein said encoding comprises using the reconstructed first enhanced layer frame as a reference frame while providing the encoded second enhanced layer frame.

17. The method of claim 16, wherein said encoding comprises using the reconstructed base layer frame as another reference frame while providing the encoded second enhanced layer frame.

18. A scalable video system, comprising:
a video decoder which decodes encoded video frames in display order and which provides decoded video frames including a decoded base layer frame, a first decoded enhanced layer frame and a second decoded enhanced layer frame; and
a memory, coupled to said video decoder, which stores said decoded base layer frame and said first decoded enhanced layer frame;
wherein said video decoder uses said first decoded enhanced layer frame as a reference frame while decoding said second decoded enhanced layer frame.

19. The scalable video system of claim 18, further comprising an input circuit which receives an input bitstream from a communication channel, and which performs inverse processing functions to convert said input bitstream to said encoded video frames.

20. The scalable video system of claim 18, wherein said video decoder is configured to store into said memory decoded base layer frames and any decoded enhanced layer frame which is to be used as a reference frame for decoding another encoded enhanced layer frame.

21. The scalable video system of claim 18, further comprising a video encoder, coupled to said memory and said video decoder, which encodes input video information in display order and which provides said encoded video frames.

22. The scalable video system of claim 21, wherein said video encoder uses said first decoded enhanced layer frame as a reference frame while encoding another enhanced layer frame.
